(19) United States
(12) Patent Application Publication
(10) Pub. No.: US 2023/0148064 A1
(43) Pub. Date: May 11, 2023

(54) Solar Charging Vehicle Accessory

(71) Applicant: David Trombley, Byron Center, MI (US)

(72) Inventor: David Trombley, Byron Center, MI (US)

(21) Appl. No.: 17/982,887

(22) Filed: Nov. 8, 2022

Related U.S. Application Data
(60) Provisional application No. 63/277,133, filed on Nov. 8, 2021.

(51) Int. Cl. B60L 8/00; B60J 7/14; B60K 11/06

(52) U.S. Cl. CPC B60L 8/003; B60J 7/141; B60K 11/06; B60L 2200/36

(57) ABSTRACT

A solar charging vehicle accessory is comprised of a substrate member, a solar panel, and an electric coupler. The substrate member covers at least a portion of an electric vehicle, the substrate including a top surface and a bottom surface. The solar panel is coupled to the top surface of the substrate. The electric coupler electrically couples the solar panel to at least one of an electric drive of the electric vehicle and a battery pack of the electric vehicle.

### CROSS-REFERENCE TO RELATED APPLICATION

The present application claims the benefit of provisional application U.S. Ser. No. 63/277,133, which was filed Nov. 8, 2021.

### BACKGROUND OF THE DISCLOSURE

### 1. Field of the Disclosure

The disclosure relates in general to a vehicle accessory, and more particularly, to a solar charging vehicle accessory.

### 2. Background Art

Currently, vehicles are on the verge of making a historic transition from an internal combustion drive or an internal combustion engine as a drive mechanism to an electric drive or an electric motor as a drive mechanism. Various sources of electricity are utilized as a source of electricity for electric vehicles, such as fuel cells and batteries. Fuel cell technology is still currently being developed, which leaves batteries as a primary source of power for these electric vehicles. Some electric vehicles still utilize the internal combustion drive in combination with the electric drive as a drive mechanism, refereed to within the vehicle industry as a hybrid vehicle. These hybrid vehicles utilize a battery that is charged by their internal combustion drive, and also employ regenerative charging. Some of these hybrid vehicles also include an electric plug that can be electrically coupled to an external power source, such as an electric grid, to charge their batteries. Other electric vehicles are entirely powered by batteries. Since these electric vehicles are entirely powered by batteries, these electric vehicles all include the electric plug.

### SUMMARY OF THE DISCLOSURE

The disclosure is directed to a solar charging vehicle accessory that is comprised of a substrate member, a solar panel, and an electric coupler. The substrate member covers at least a portion of an electric vehicle, the substrate including a top surface and a bottom surface. The solar panel is coupled to the top surface of the substrate. The electric coupler electrically couples the solar panel to at least one of an electric drive of the electric vehicle and a battery pack of the electric vehicle.

In at least one configuration, the electric vehicle is an electric pickup truck and the solar charging vehicle accessory is a tonneau cover to cover a bed of the electric pickup truck.

In at least one configuration, the electric vehicle is an electric pickup truck and the solar charging vehicle accessory is cap to cover a bed of the electric pickup truck.

In at least one configuration, the solar charging vehicle accessory further comprises an actuator to change an angle of the solar panel.

In at least one configuration, the solar charging vehicle accessory further comprises a cooling system including at least one air intake disposed on an end of the substrate member facing a direction of travel of the vehicle, at least one air outlet to discharge the air from the at least one air intake, and a battery pack, the air from the air intake cooling the battery pack.

### BRIEF DESCRIPTION OF THE DRAWINGS

The disclosure will now be described with reference to the drawings wherein:

FIG. 1 illustrates a schematic view of an example solar charging vehicle accessory disposed onto an example vehicle, a bed of a pickup truck, in accordance with at least one configuration disclosed herein;

FIG. 2 illustrates an isometric view another example solar charging vehicle accessory disposed onto an example vehicle, a bed of a pickup truck, in accordance with at least one configuration disclosed herein;

FIG. 3 illustrates an isometric view of the solar charging vehicle accessory disposed to create access to the bed of the pickup truck shown in FIG. 2, in accordance with at least one configuration disclosed herein;

FIG. 4 illustrates an isometric view of the solar charging vehicle accessory disposed to create another access to the bed of the pickup truck shown in FIG. 2, in accordance with at least one configuration disclosed herein;

FIG. 5 illustrates an isometric view of the solar charging vehicle accessory disposed to create even another access to the bed of the pickup truck shown in FIG. 2, in accordance with at least one configuration disclosed herein;

FIG. 6 illustrates an isometric view of another example solar charging vehicle accessory disposed onto the bed of the pickup truck, in accordance with at least one configuration disclosed herein;

FIG. 7 illustrates an isometric view of the solar charging vehicle accessory disposed to create access to the bed of the pickup truck shown in FIG. 6, in accordance with at least one configuration disclosed herein;

FIG. 8 illustrates an isometric view of the solar charging vehicle accessory disposed to create another access to the bed of the pickup truck shown in FIG. 6, in accordance with at least one configuration disclosed herein;

FIG. 9 illustrates an isometric view of the solar charging vehicle accessory disposed to create even another access to the bed of the pickup truck shown in FIG. 6, in accordance with at least one configuration disclosed herein;

FIG. 10 illustrates an isometric view of another example solar charging vehicle accessory disposed onto the bed of the pickup truck, in accordance with at least one configuration disclosed herein;

FIG. 11 illustrates an isometric view of the solar charging vehicle accessory disposed to create access to the bed of the pickup truck shown in FIG. 10, in accordance with at least one configuration disclosed herein;

FIG. 12 illustrates an isometric view of another example solar charging vehicle accessory disposed onto the bed of the pickup truck, in accordance with at least one configuration disclosed herein;

FIG. 13 illustrates an isometric view of another example solar charging vehicle accessory disposed onto the bed of the pickup truck, in accordance with at least one configuration disclosed herein;

FIG. 14 illustrates an isometric view of another example solar charging vehicle accessory disposed onto a top of an example vehicle, in accordance with at least one configuration disclosed herein;

FIG. 15 illustrates an isometric view of the solar charging vehicle accessory, shown in FIG. 14, disposed at an angle with respect to the top of the vehicle, in accordance with at least one configuration disclosed herein;

FIG. 16 illustrates an isometric view of the solar charging vehicle accessory, shown in FIG. 14, disposed at another angle with respect to the top of the vehicle, in accordance with at least one configuration disclosed herein;

FIG. 17 illustrates an isometric view of the solar charging vehicle accessory, shown in FIG. 14, disposed at yet another angle with respect to the top of the vehicle, in accordance with at least one configuration disclosed herein;

FIG. 18 illustrates an isometric view of another example solar charging vehicle accessory disposed onto a top of an example vehicle, in accordance with at least one configuration disclosed herein;

FIG. 19 illustrates an isometric view of the solar charging vehicle accessory in another configuration disposed onto the top of the vehicle shown in FIG. 18, in accordance with at least one configuration disclosed herein;

FIG. 20 illustrates an isometric view of the solar charging vehicle accessory in another configuration disposed onto the top of the vehicle shown in FIG. 18, in accordance with at least one configuration disclosed herein;

FIG. 21 illustrates an isometric view of an example cooling system for use with any of the solar example solar charging vehicle accessories shown in FIGS. 1-20, in accordance with at least one configuration disclosed herein;

FIG. 22 illustrates an example cell phone app executing on an example cell phone that can control an example actuator of any of the solar example solar charging vehicle accessories shown in FIGS. 1-20, in accordance with at least one configuration disclosed herein; and

FIG. 23 illustrates an example schematic representation of a general-purpose computing device that can be used with at least one of the solar charging vehicle accessories and smart phone disclosed herein, in accordance with at least one configuration disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

It has come to be appreciated that electric vehicles are exposed to solar energy or sunlight during a large portion of a day, even those electric vehicles that are garaged during some portion of the day. In accordance with configurations disclosed herein, at least one of various solar charging vehicle accessories disclosed herein that can be coupled to an electric vehicle. The solar charging vehicle accessories can be coupled to at least one of the electric drive to power the electric drive while the electric vehicle is being driven and a battery pack of the electric vehicle to charge the battery pack. All of the solar panels discussed below can be sized to maximize solar collection and power generation, substantially covering an entirety of the substrate members onto which the solar panels are coupled.

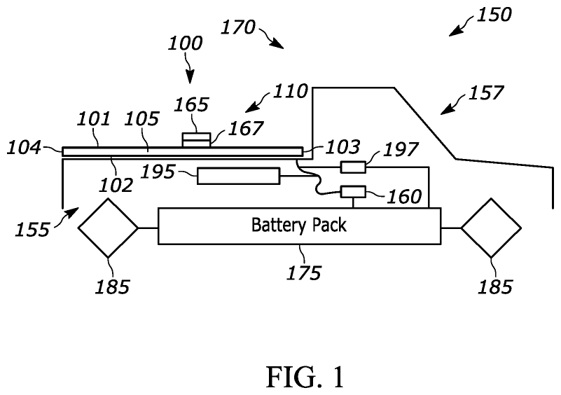

FIG. 1 shows a solar charging vehicle accessory, in this configuration a truck bed cover or tonneau cover 100 that in use is physically coupled to an electric vehicle, such as an electric pickup truck 150, together forming a system 170. Typical tonneau covers are typically aftermarket accessories that are coupled to a truck. The tonneau cover 100 can be an aftermarket accessory that is coupled to the electric pickup truck 150, or alternatively an accessory that is provided by a manufacturer of the electric pickup truck 150. The tonneau cover 100 includes a frame 110 that is physically sized and coupled to a bed 155 of the electric pickup truck 150, such as via fasteners (e.g., bolts).

The tonneau cover 100 further includes a top side 101 and a bottom side 102, the top side 101 facing the sun and the bottom side 102 facing the bed 155 of the electric pickup truck 150. In at least one configuration, the tonneau cover 100 can include a substrate member 105 (e.g., plastic, aluminum, or any other material that can serve as a substrate member) that provides rigidity to the tonneau cover 100 and which can be a one piece member from a first end 103 of the substrate member 105 closest to a cab 157 of the electric pickup truck 150 to a second end 104 closest to a tail 158 of the pickup truck 100, forming a rectangular planar surface thereacross that is sized to cover the bed 155.

The tonneau cover 100 further includes at least one solar panel 110 comprised of a plurality of solar cells, disposed on a top of the substrate member 105. The plurality of solar cells of the solar panel 110 are coupled together to form the solar panel 110 that is physically fixedly coupled (e.g., adhesive, clips, bolts, or any other coupler) to the substrate member 105, the substrate member 105 being physically coupled to the frame 110 to prevent the tonneau cover 100 from moving when so desired. The tonneau cover 100, via the solar panel 100, collects solar energy in either a folded down configuration or a raised configuration. The solar panel 110 is electrically coupled to a rechargeable battery pack 175 of the electric pickup truck 150 and/or at least one electric motor 185 of the electric pickup truck 150. The solar panel 110 can charge the battery pack 175 and/or power the electric motor 185 of the electric pickup truck 150 during use of the electric pickup truck 150.

In at least one configuration, the tonneau cover 100 can further include a rechargeable battery pack 195 to store power separate from the battery pack 175 of the electric pickup truck 150. The rechargeable battery pack 195 can be integrated with the tonneau cover 100, or separate from the tonneau cover 100. The solar panel 110 is electrically coupled to this battery pack 175. In at least one configuration, the tonneau cover 100 can further include a power converter 197 that can convert Direct Current (DC) power from the solar panel 110 to Alternating Current (AC) that can be used to charge the battery pack 175 of the electric pickup truck 150. The power converter 197 can be integrated with the tonneau cover 100 or can be a distinct apparatus electrically coupled to the tonneau cover 100. In at least one configuration, the electric pickup truck 150 includes a DC connector 160 that is coupled to at least one of the battery pack 175 and the electric motor 185, through which at least one of the solar panel 110 and the battery pack 195 provides power thereto.

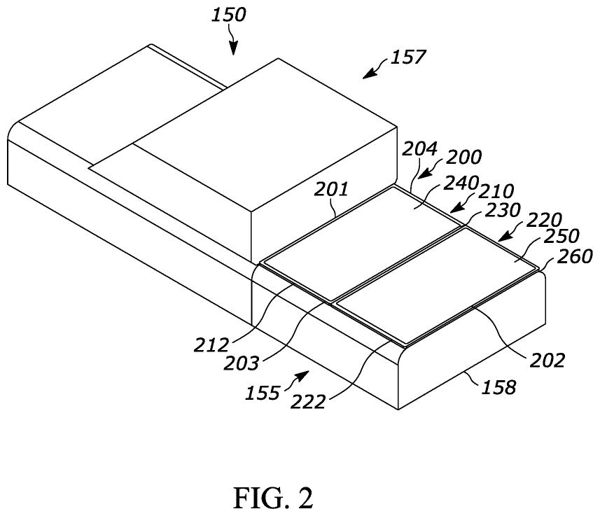

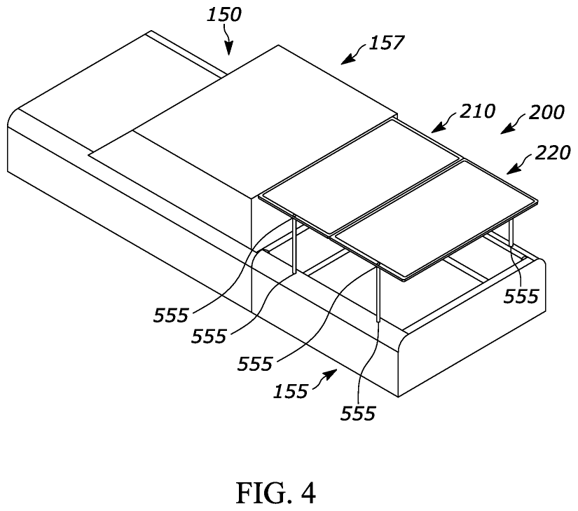

Now with reference to FIGS. 2-5, another configuration of a solar charging vehicle accessory is disclosed, a tonneau cover 200. In this example, the tonneau cover 200 includes a first cover member 210 and a second cover member 220 that are both hingedly coupled to each over via a hinge 230 that is disposed approximately half a distance between the tail 158 of the electric pickup truck 150 and the cab 157 of the electric pickup truck 150. This hinge 230 can be a cloth, a plastic, metal, or any other material that is able to hingedly couple the first cover member 210 with the second cover member 210. The first and second cover members 210, 220 include first and second substrate members 212, 222 onto which first and second solar panels 240, 250 are physically fixedly, at least similar to the solar panel 110 discussed above. The first and second substrate members 212, 222 can be removably coupled to a frame 260 that is coupled to the bed 155.

The first and second solar panels 210, 220 are electrically coupled to each other such that the first and second solar panels 210, 220 produce a single power source to charge the battery pack 175 of the electric pickup truck 150 and/or to power at least one electric motor 185 of the electric pickup truck 150, as discussed above. Electric lines (not shown) can be used for such electrical coupling.

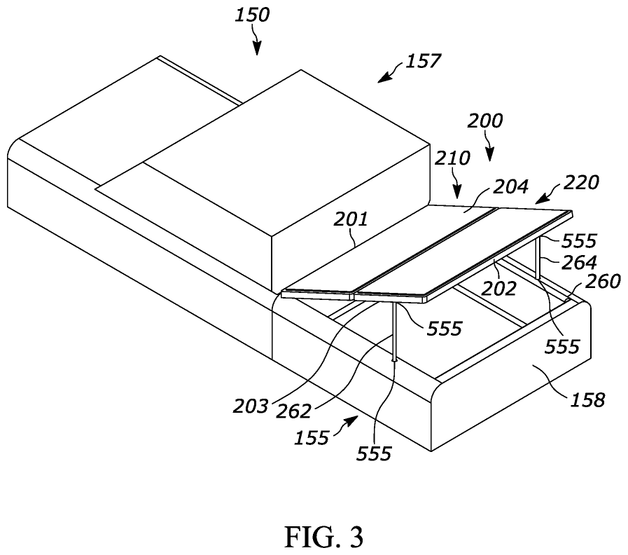

The tonneau cover 200 can be placed into various configurations. FIG. 2 shows the tonneau cover 200 in a planar configuration to completely cover the bed 155 of the electric pickup truck 150. FIGS. 3-5 show the tonneau cover 200 in various configurations that provide access to the bed 155. In particular, FIG. 3 shows the tonneau cover 200 hinging along a first end 201 thereof, closest to the cab 157. The tonneau cover 200 is shown as remaining in a planar configuration, with a second end 202 of the tonneau cover 200 shown as being held away from the bed 155 by first and second frame arms 262, 264, of the frame 260, disposed on first and second sides 203, 204 of the tonneau cover 200.

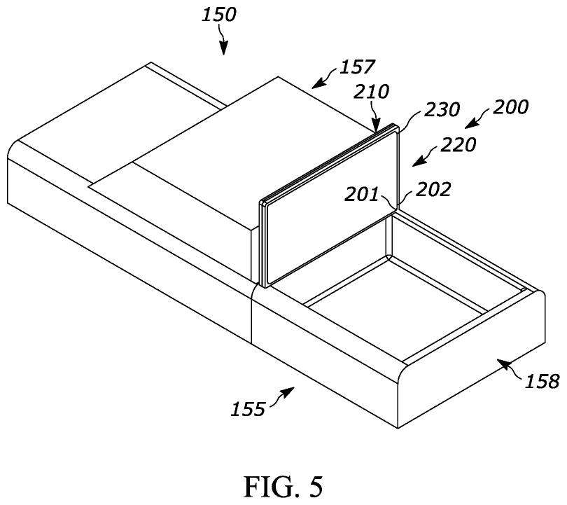

In at least one configuration, the first and second frame arms 262, 264, can be hingedly coupled on a first end thereof to sides of the second substrate member 222 and to the frame 260 on a second end thereof, as shown. In at least one configuration, third and fourth frame arms 266, 268, of the frame 260, can be disposed on first and second sides 203, 204 of the tonneau cover 200. In at least one configuration, the third and fourth frame arms 266, 268, can be hingedly coupled on a first end thereof to sides of the first substrate member 212 and to the frame 260 on a second end thereof, as shown. The tonneau cover 200 can be raised such that the tonneau cover 200 can be placed parallel to the bed 155 to provide access to the bed 155, as shown. In at least one configuration, the first and second cover members 210, 220 can be folded onto each other, such that the first and second cover members 210, 220 are disposed onto the cab 157, as shown in FIG. 5.

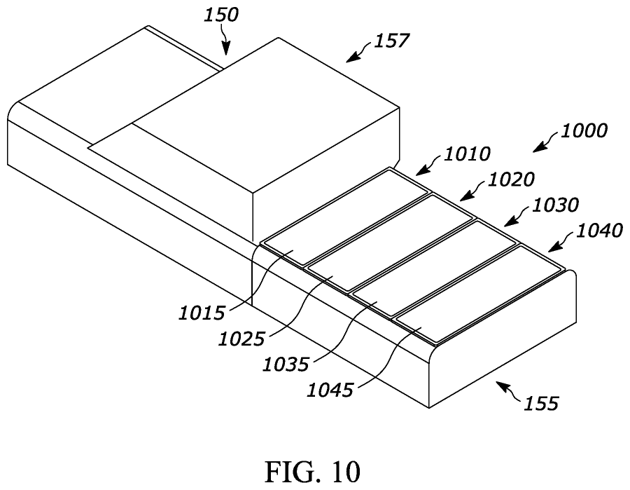

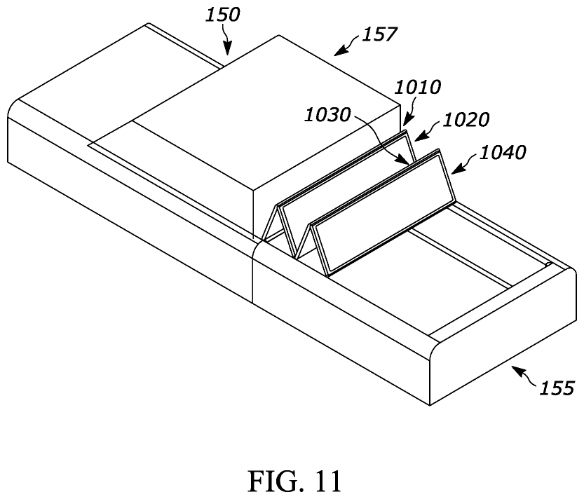

In at least one other configuration, even another solar charging vehicle accessory that can utilize a similar configuration to the tonneau cover 200 but includes additional cover members is disclosed, such as tonneau cover 1000 shown in FIGS. 10 and 11. The tonneau cover 1000 instead includes four cover members 1010, 1020, 1030, 1040 that are hingedly coupled together and onto which four solar panels 1015, 1025, 1035, 1045 are disposed, respectively. Similar to the tonneau cover 200, the tonneau cover 1000 can be folded along hinges such that the tonneau cover 1000 is disposed against the cab 157, as shown in FIG. 11.

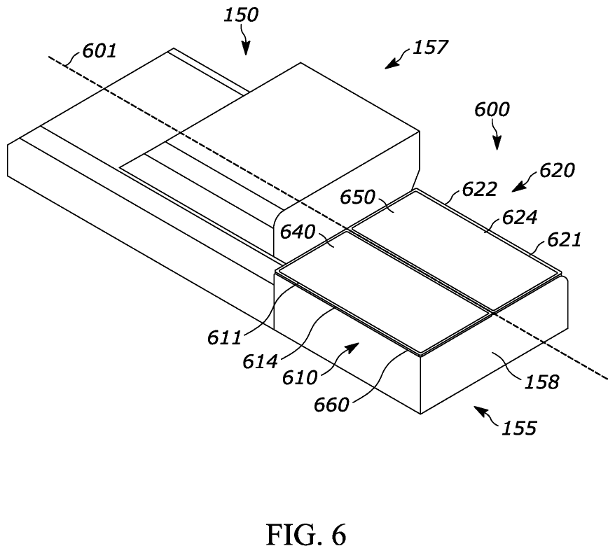

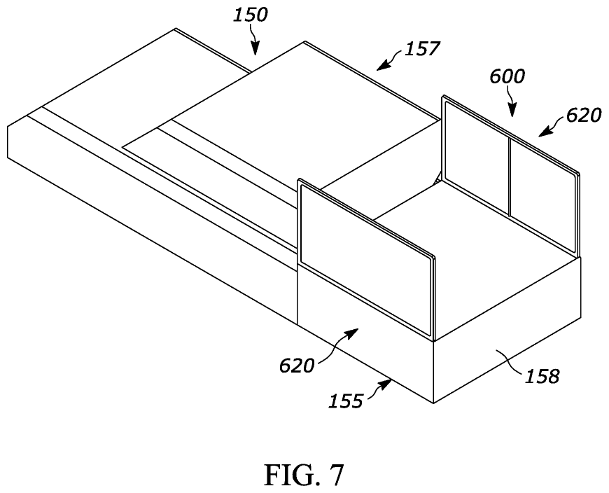

With reference to FIGS. 6-9, yet another configuration of a solar charging vehicle accessory is disclosed, a tonneau cover 600. In this example, the tonneau cover 600 includes a first cover member 610 and a second cover member 620 that are both hingedly coupled, via first and second hinges 611, 621 to a frame 660 on outside edges 612, 622 of each of the first and second cover members 610, 620, shown in FIG. 7. The first and second cover members 610, 620 can rotate about the hinges 611, 621 to a vertical orientation to provide access to the bed 155. The first and second cover members 610, 620 are rectangular in shape, with long edges thereof being parallel with sides of the electric pickup truck 150, and meeting when folded to form a planar surface at a centerline 601 of the electric pickup truck 150, as shown. These first and second hinges 611, 621 can be a cloth, a plastic, metal, or any other material that is able to hingedly couple the first and second cover member 610, 620 to the frame 660. The first and second cover members 610, 620 include first and second substrate members 614, 624, respectively, onto which first and second solar panels 640, 650 are physically fixedly, at least similar to the solar panel 110 discussed above. The first and second substrate members 614, 624 can be removably coupled to the frame 660 that is coupled to the bed 155.

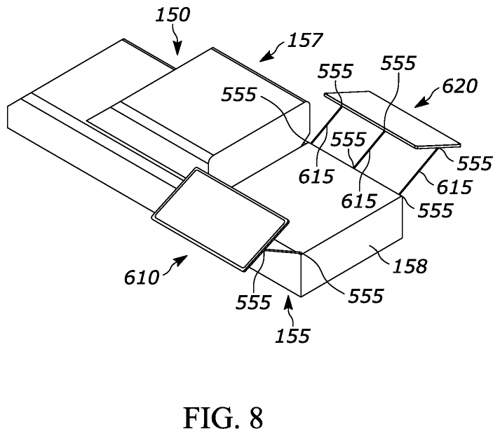

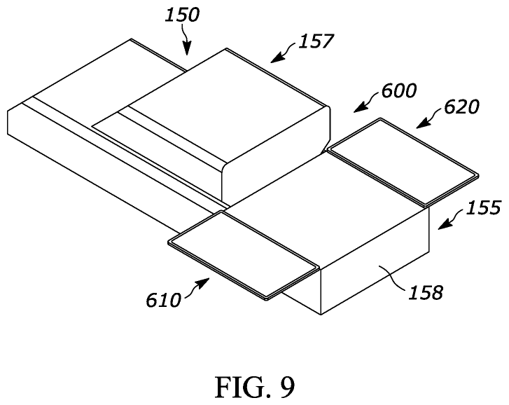

The first and second cover members 610, 620 can be coupled to the frame 600 via a plurality of frame arms 615, in at least one configuration. In at least one configuration, three (3) such frame arms 615 are coupled to each of the first and second cover members 610, 620, such as centrally to a bottom of the first and second cover members 610, 620, as shown. The frame arms 610 allow the first and second cover members 610, 620 to swivel away from the centerline 601 of the electric pickup truck 150, as shown in FIGS. 8 and 9. The first and second cover members 610, 620 can be swiveled away from the centerline 601 to be disposed alongside the bed 155, as shown in FIG. 9.

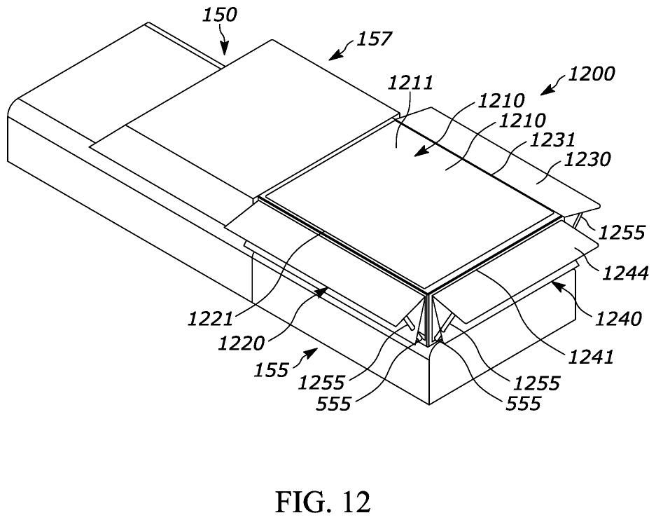

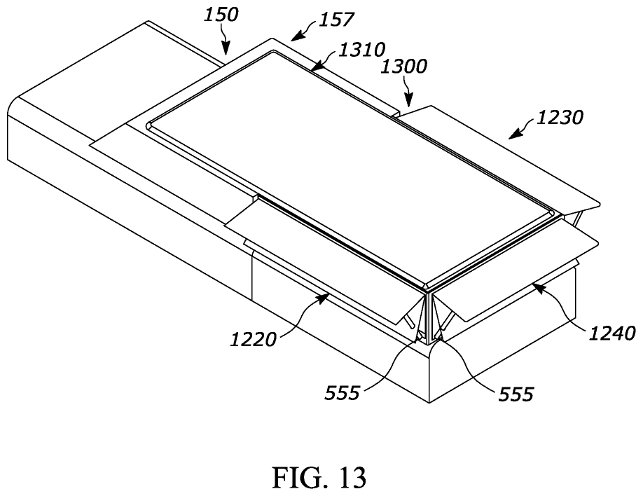

With reference to FIGS. 12 and 13, yet another type of solar charging vehicle accessory is disclosed, a pickup truck bed cover or cap 1200 is disclosed that in use is physically coupled to the bed 155 of the electric pickup truck 150. Typical truck caps are aftermarket accessories that are coupled to a truck. The cap 1200 can be an aftermarket accessory that is coupled to the electric pickup truck 150. The cap 1200 can include any of the features discussed above for the tonneau cover 100. The cap 1200 can include solar panels disposed on at least one outside surface thereof. In at least one configuration, to maximize an amount of solar energy collected by the cap 1200, the cap includes four (4) solar panels coupled to substrate members. The cap 1200 includes a first cover member 1210, including a first solar panel 1211 coupled thereto, coupled to a top of the cap 1200, and second, third, and fourth cover members 1220, 1230, 1240, including second, third, and fourth solar panels 1222, 1233, 1244 coupled to two sides and a back of the cap 1200, respectively, similar to the solar panels discussed above. As shown, the second, third, and fourth panels 1220, 1230, 1240 can be coupled to the two opposite sides and the back of the cap 1200, respectively, via hinges 1221, 1231, 1241, respectively. In at least one configuration shown in FIG. 13, the first cover member 1210 can be sized to not only cover a top surface of the cap 1200, but further sized to cover a top surface of the cab 157, shown as first solar panel 1310 of cap 1300 which is included with another solar charging vehicle accessory.

In at least one configuration, the cap 1200 can further include frame arms 1255 to raise the second, third, and fourth solar panels 1220, 1230, 1240 such that the second, third, and fourth solar panels 1220, 1230, 1240 can be disposed as various angles with respect to sides of the cap 1200. As shown, the second, third, and fourth solar panels 1220, 1230, 1240 are disposed at approximately forty-five (45) degree angles with respect to sides of the cap 1200, but can be disposed at any angle with respect to the cap 1200 without limitation.

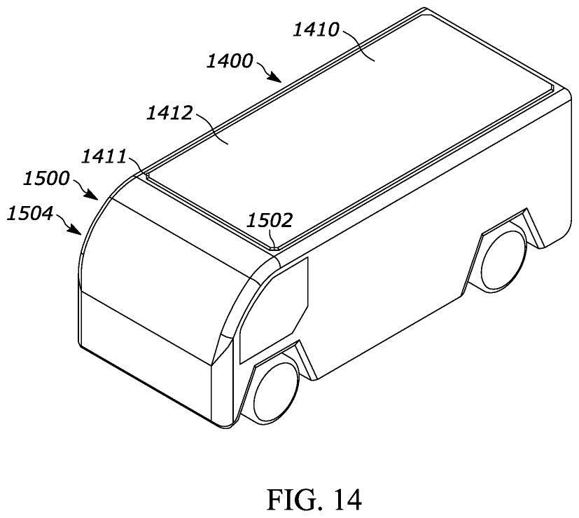

With reference to FIGS. 14-17, even another type of solar charging vehicle accessory is disclosed, such as roof cover 1400 that can be coupled to a roof of a vehicle, in this example an electric vehicle 1500 which larger than the electric pickup truck 150. The roof cover 1400 can include any of the features discussed above for the tonneau cover 100. The electric vehicle 1500 can be a bus, a tractor trailer truck, a cargo van, a food truck, or any other vehicle that includes a roof having a large planar top surface 1502 onto which at least one cover member, such as cover member 1410 can be coupled. As with the cover members discussed above, the cover member 1410 can include at least one substrate 1411 onto which at least one solar panel 1412 is coupled. In at least one configuration, the roof cover 1400 is disposed atop the electric vehicle 1500 such that the roof cover 1400 does not overhang the vehicle, as shown, although overhanging is possible.

In at least one configuration, an actuator 555 (e.g., electric motor) can be disposed between a vehicle and any of the cover members disclosed herein to move the cover member into various orientations, such as various angles, to point the cover member toward the sun to maximize power generation by the cover member. With the examples shown in FIGS. 1, 3, 4, 8, 12, the actuator 555 can be coupled to any of the frame arms 262, 264, 266, 268, 615, 1255 to raise and lower any corner of the tonneau covers 200, 600, 1000 and cover members 1210, 1220, 1230, respectively. Likewise, the actuator 555 can be coupled to either a single end or both ends of the plurality of frame arms 262, 264, 266, 268, 615, 1255 to raise and lower any corner of the tonneau covers 200, 600, 1000 and cover members 1210, 1220, 1230, respectively.

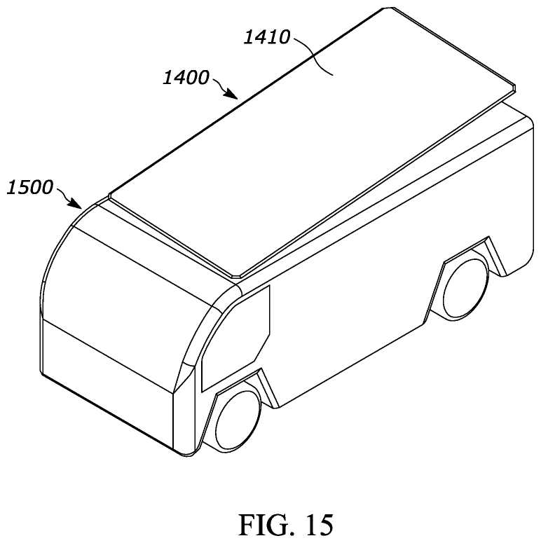

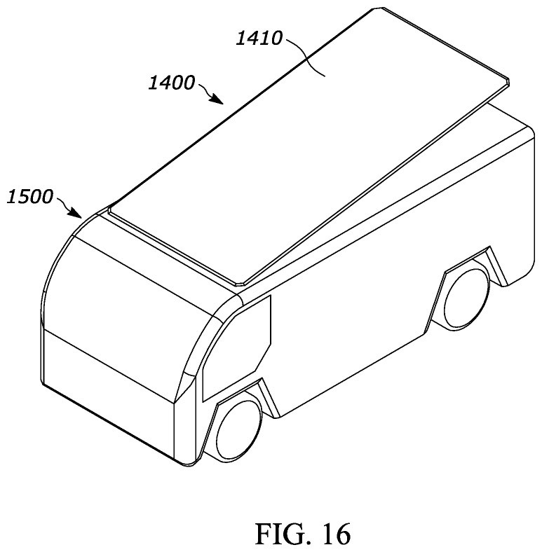

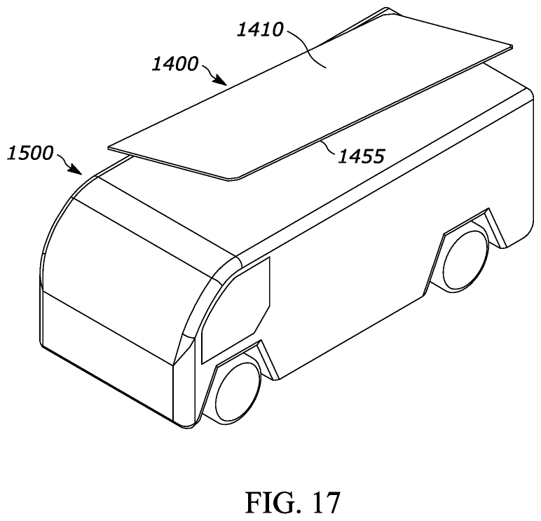

FIG. 14 shows another configuration in which another type of actuator, actuator 1455 (FIG. 17) is centrally physically coupled to the roof cover 1400 and physically coupled to the top surface 1502 of the electric vehicle 1500. The actuator 1455 can move the roof cover 1400 to any angle with respect to this top surface 1502. For example, as shown in FIG. 14 the actuator 1455 can move the roof cover 1400 such that the roof cover 1400 is parallel with respect to the top surface 1502 of the vehicle. The actuator 1455 can further move the roof cover 1400 such that the roof cover 1400 is raised at a back of the electric vehicle 1500 but remains at a lowest configuration at a front of the electric vehicle 1500, closest to a cab 1504 of the electric vehicle 1500, as shown in FIG. 15. As shown in FIG. 16, the actuator 1455 can further move the roof cover 1400 such that the roof cover 1400 is further raised at a back of the electric vehicle 1500 from that shown in FIG. 15, but still remaining at a lowest configuration proximate a front of the electric vehicle 1500, closest to a cab 1504 of the electric vehicle 1500. The actuator 1455 is further shown in FIG. 17 as having moved the roof cover 1400 such that the roof cover 1400 is tilted toward a rear right corner of the electric vehicle 1500. Thus, the actuator 1455 can move the roof cover 1400 at any desired angle with respect to the top surface 1502 of the electric vehicle 1500 to maximize power generation by the solar panel 1412.

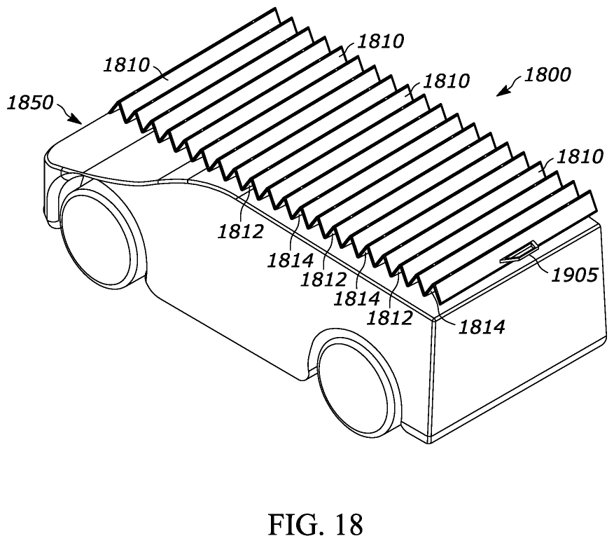

FIG. 18 shows even another type of solar charging vehicle accessory, a removable cover 1800. The removable cover 1800 is the type of cover that would be temporarily disposed atop a vehicle 1850, such as a car or truck, when the vehicle 1850 is exposed to the sun, but not being driven. Many vehicles are parked for extended periods of time when not being driven. Some vehicles are parked outside of a garage, such as when owners of such vehicles do not own a garage or when such owners are at work. Taking advantage of such extended periods of time with exposure to the sun, the removable cover 1800 includes a plurality of cover members including a plurality of solar panels 1810 that can generate power for the vehicle 1850.

The removable cover 1800 is similar to the covers discussed above in that the removable cover 1800 includes a plurality of substrate members 1812 onto which the plurality of solar panels 1810 are fixed, respectively. However, because the removable cover 1800 is configuration to be repeatedly disposed atop the vehicle 1850 when the vehicle 1850 is not in use, and taken off of the vehicle 1850 when being driven, a non-abrasive material 1814 is disposed onto a bottom surface of the plurality of substrate members 1814, respectively, to at least mitigate damage to the electric vehicle 1850, such as scratching of a paint of the electric vehicle 1850. This non-abrasive material 1814 can be at least one of a cloth (e.g., a felt), a spray-on material, a painted-on material, or any other material that at least mitigates damage to the electric vehicle 1850.

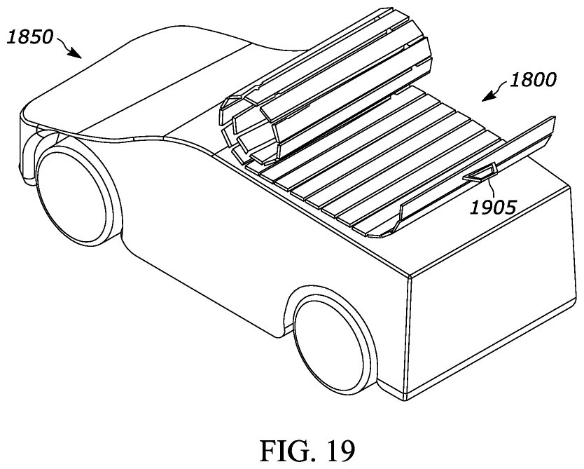

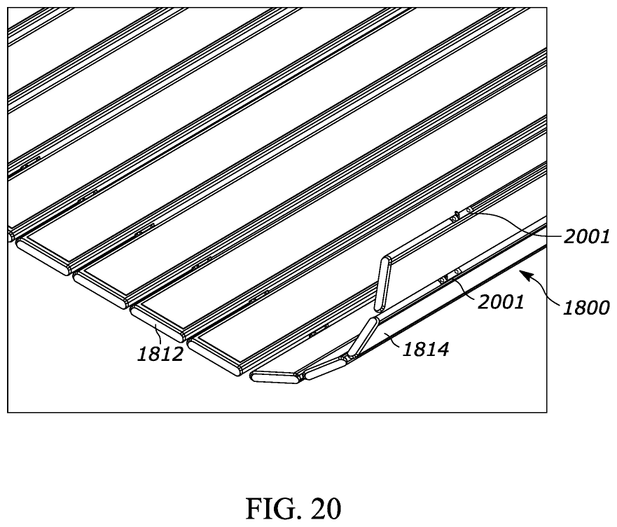

As shown in more detail in FIG. 20, the plurality of substrate members 1812 are coupled together via a plurality of hinges 2001 disposed therebetween. In at least one configuration, at least two (2) of such hinges 2001 are disposed between any two (2) substrate members 1812 proximate to ends thereof, although more or less hinges 2001 are possible. The hinges 2001 allow the removable cover 1800 to fold like an accordion, as shown in FIG. 18, such that the removable cover 1800 can be shortened or lengthened for shorter and longer vehicles, respectively. The hinges 2001 also allow the removable cover 1800 to be rolled up for storage, and unrolled when disposed atop the electric vehicle 1850, as shown in FIG. 19. For convenience of carrying and positioning by a user, the removable cover 1800 can include at least one handle, such as handle 1905 (FIG. 19) that is fixedly coupled to an end substrate member 1812, as shown.

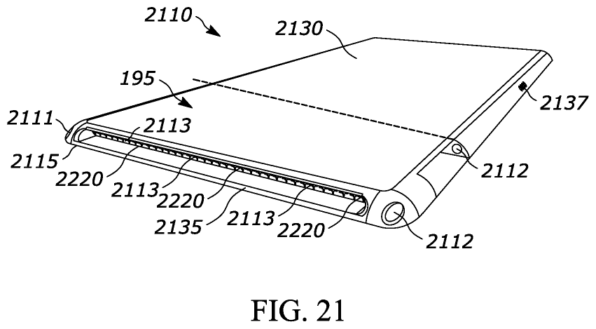

To assist with cooling at least one of the battery pack 195 and the any of the solar panels discussed above, FIG. 21 shows a cooling system 2110 that can be integrated within a cover 2100. The cover 2100 can be similarly configurated to tonneau cover 100 and can be similarly coupled to a vehicle (not shown), as discussed above, such as including a solar panel 2130 disposed on top of a cover member 2135 thereof. The battery pack 195 can be disposed proximate to one end thereof, such as an end 2115 that faces a direction of travel of the vehicle, as shown. FIG. 21 further shows that, in at least one configuration, a plurality of air intakes, air intakes 2113 that face a direction of travel of the vehicle can be disposed across the end 2115 of the cover 2100, substantially from one side of the cover 2100 to another, as shown. Such air intakes 2113 can be equally spaced therebetween. The cover 2100 further includes ducting (not shown) within the cover 2100 to direct air entering the air intakes 2113 over the battery pack 195, under the solar panel 2130 through the cover member 2135. The air can be discharged through the cover member 2135 via at least one air outlet, such air outlets 2137. Although twenty-six (26) air intakes 2113 and four (4) air outlets 2137 are shown, the cover 2100 can include more or less air intakes and/or air outlets without departing from the scope of this disclosure. In at least one configuration, the cover 2100 can further include two (2) air intakes 2111, 2112 disposed at the end 2115 and corners of the cover 2100 that face a direction of travel of the vehicle. The air intakes 2111, 2112 are cut at an angle (e.g., forty-five degrees) such that they capture air as the vehicle is traveling.

In at least one configuration, the cooling system 2100 can further include a plurality of propellers 2220. The plurality of propellers 2220 can be disposed within at least some of the ducting and/or the air intakes 2113. These plurality of propellers 2220 are individually coupled to electrical generators (not shown), respectively, that when actuated produce power to charge the battery pack 195.

Any of the solar charging vehicle accessories 100, 200, 600, 1000, 1200, 1300 disclosed above can be “smart” solar charging vehicle accessories, in accordance with at least one configuration, that are configured to included moving solar panels, as discussed herein. The actuator 555 disclosed above can, in at least one configuration, be used in conjunction with any of the solar charging vehicle accessories 100, 200, 600, 1000, 1200, 1300 to change an angle of any of the solar panels thereof

The solar charging vehicle accessories 100, 200, 600, 1000, 1200, 1300 can further include a solar sensor 165 (FIG. 1) coupled to a top of any of the solar charging vehicle accessories 100, 200, 600, 1000, 1200, 1300. The solar charging vehicle accessories 100, 200, 600, 1000, 1200, 1300 can self monitor via the solar sensor 165 a direction of the sun and move, via the actuator 555, any of the solar panels discussed above toward the sun to maximize power generation by the solar panels. In at least one configuration, the solar charging vehicle accessories 100, 200, 600, 1000, 1200, 1300 can even further include a motion sensor 167. The solar charging vehicle accessories 100, 200, 600, 1000, 1200, 1300 can move the solar panels discussed above after the solar charging vehicle accessories 100, 200, 600, 1000, 1200, 1300 have determined, via the motion sensor 167, that the vehicle to which the solar charging vehicle accessories 100, 200, 600, 1000, 1200, 1300 are coupled has not moved for a predetermined amount of time, e.g., 5 minutes, to maximize power generation by the solar panels.

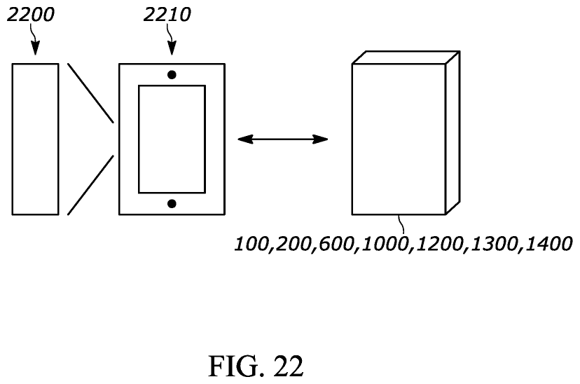

With reference to FIG. 22, a wireless device 2210 (e.g., cell phone, tablet computer, etc.) can execute a solar accessor application or solar accessory “app” 2200. In place of the motion sensor 167 discussed above, the wireless device 2210 can include a motion sensor (not shown) integrated therein to monitor a motion of the wireless device 2210. The wireless device 2210 can infer from such motion that the vehicle to which any of the solar charging vehicle accessories 100, 200, 600, 1000, 1200, 1300 are coupled is no longer in motion, e.g., either a user has walked away from a parked vehicle or the owner is sitting in a stationary vehicle for a predetermined amount of time, e.g., 5 minutes. The wireless device 2210 can then transmit an instruction to any of the solar charging vehicle accessories 100, 200, 600, 1000, 1200, 1300 to raise their solar panels to maximize power generation by the solar panels.

The solar accessory app 2200 can further track an orientation of a vehicle within which the wireless device 2210 is disposed. Such orientation includes a direction of the vehicle relative to magnetic north. The solar accessory app 2200 can further track a time of day, and based on the time of day and the orientation of the vehicle, the solar accessory app 220 can determine a direction of the sun relative to any of the solar charging vehicle accessories 100, 200, 600, 1000, 1200, 1300. The solar accessory app 220 can then actuate the actuator 555 to orient the solar panels discussed above from the solar charging vehicle accessories 100, 200, 600, 1000, 1200, 1300 toward the sun to maximize power generation by the solar panels.

In at least one configuration, the solar accessory app 2200 can include a navigation feature. The solar accessory app 2200 can use the determined direction of the sun relative to the vehicle to provide routing directions that maximize a time and/or direction that the solar panels are exposed to the sun, to maximize power generation by the solar panels. Thus, the solar accessory app 2200 selects a route, from a plurality of possible routes, that increases a time and/or optimizes an orientation of the solar panels with respect to the sun.

Having determined an orientation of the vehicle within which the wireless device 2210 is disposed, as discussed above, the solar accessory app 2200 can further provide a visual indication to a user of a best orientation to park their vehicle to maximize power generation by the solar panels. For example, the solar accessory app 2200 can display a first arrow for the user that provides a direction that maximizes power generation by the solar panels, and a second arrow that shows a current orientation of the vehicle. The user would then have to move the vehicle such that the first and second arrow align to maximize power generation by the solar panels, or at least nearly aligned to at least increase power generation by the solar panels from their current orientation.

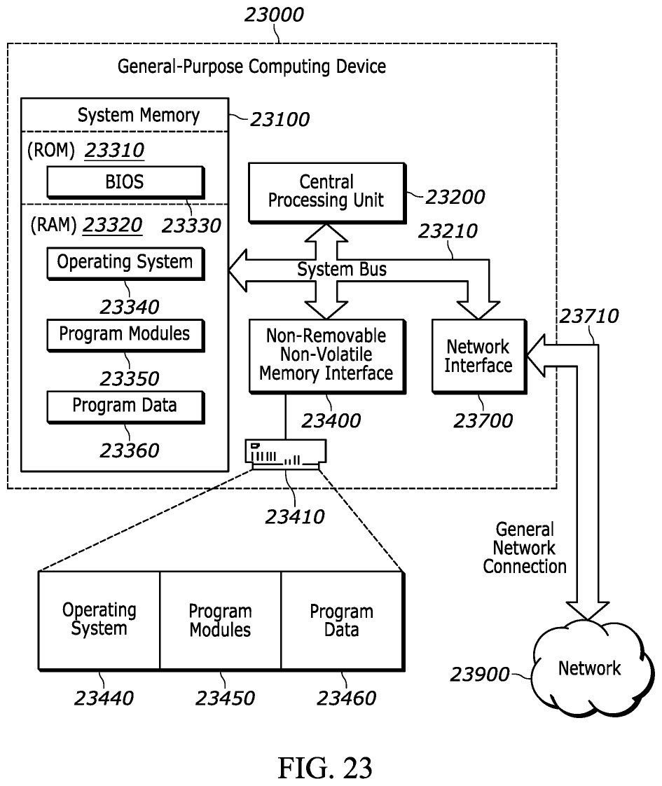

With reference to FIG. 23, an exemplary apparatus, such as a general-purpose computing device, is illustrated in the form of the exemplary general-purpose computing device 23000. The general-purpose computing device 23000 may be of the type utilized for any of the covers 100, 200, 600, 1000, 23200, 23300, 23400 described above and the wireless device 2210 (FIG. 22). As such, it will be described with the understanding that variations can be made thereto. The exemplary general-purpose computing device 23000 can include, but is not limited to, one or more central processing units (CPUs) 23200, a system memory 23300, such as including a Read Only Memory (ROM) 23310 to store a Basic Input/Output System (BIOS) 23330 and a Random Access Memory (RAM) 1320, and a system bus 23210 that couples various system components including the system memory to the processing unit 23200. The system bus 23210 may be any of several types of bus structures including a memory bus or memory controller, a peripheral bus, and a local bus using any of a variety of bus architectures. Depending on the specific physical implementation, one or more of the CPUs 23200, the system memory 23300 and other components of the general-purpose computing device 23000 can be physically co-located, such as on a single chip. In such a case, some or all of the system bus 23210 can be nothing more than communicational pathways within a single chip structure and its illustration in FIG. 23 can be nothing more than notational convenience for the purpose of illustration.

The general-purpose computing device 23000 also typically includes computer readable media, which can include any available media that can be accessed by computing device 23000. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 23000. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 23000 may operate in a networked environment via logical connections to one or more remote computers. The logical connection depicted in FIG. 23 is a general network connection 23710 to the network 23900, which can be a local area network (LAN), a wide area network (WAN) such as the Internet, or other networks. The computing device 23000 is connected to the general network connection 23710 through a network interface or adapter 23700 that is, in turn, connected to the system bus 23210. In a networked environment, program modules depicted relative to the general-purpose computing device 23000, or portions or peripherals thereof, may be stored in the memory of one or more other computing devices that are communicatively coupled to the general-purpose computing device 23000 through the general network connection 23710. It will be appreciated that the network connections shown are exemplary and other means of establishing a communications link between computing devices may be used.

The general-purpose computing device 23000 may also include other removable/non-removable, volatile/nonvolatile computer storage media. By way of example only, FIG. 23 illustrates a hard disk drive 23410 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 23410 is typically connected to the system bus 23210 through a non-removable memory interface such as interface 23400.

The drives and their associated computer storage media discussed above and illustrated in FIG. 23, provide storage of computer readable instructions, data structures, program modules and other data for the general-purpose computing device 23000. In FIG. 23, for example, hard disk drive 23410 is illustrated as storing operating system 23440, other program modules 23450, and program data 23460. Note that these components can either be the same as or different from operating system 23440, other program modules 23450 and program data 23460, stored in RAM 1320. Operating system 23440, other program modules 23450 and program data 23460 are given different numbers here to illustrate that, at a minimum, they are different copies.

With reference to FIGS. 1-21, again, the foregoing description applies to any of the covers 100, 200, 600, 1000, 23200, 23300, 23400 described above and the wireless device xxx (FIG. 22), as well as to any other computing devices in communication with these devices via the network 23900. The network interface 23710 facilitates outside communication in the form of voice and/or data. For example, the communication module may include a connection to a Plain Old Telephone Service (POTS) line, or a Voice-over-Internet Protocol (VOIP) line for voice communication. In addition, the network interface 23710 may be configured to couple into an existing network, through wireless protocols (Bluetooth, 802.11a, ac, b, g, n, or the like) or through wired (Ethernet, or the like) connections, or through other more generic network connections. In still other configurations, a cellular link can be provided for both voice and data (i.e., GSM, CDMA or other, utilizing 2G, 3G, and/or 4G data structures and the like). The network interface 23710 is not limited to any particular protocol or type of communication. It is, however, preferred that the network interface 23710 be configured to transmit data bi-directionally, through at least one mode of communication. The more robust the structure of communication, the more manners in which to avoid a failure or a sabotage with respect to communication, such as to collect healthcare information in a timely manner.

The programming modules 23450 comprise a user interface which can configure the healthcare information collection system 10. In many instances, the programming modules 23450 comprises a keypad with a display that is connected through a wired connection with the processing unit 23200. Of course, with the different communication protocols associated with the network interface 23700, the network interface 23700 may comprise a wireless device that communicates with the network 23900 through a wireless communication protocol (i.e., Bluetooth, RF, WIFI, etc.). In other embodiments, the programming modules 23450 may comprise a virtual programming module in the form of software that is on, for example, a smartphone, in communication with the network interface 23700. In still other embodiments, such a virtual programming module may be located in the cloud (or web based), with access thereto through any number of different computing devices. Advantageously, with such a configuration, a user may be able to communicate with the healthcare information collection system 10 remotely, with the ability to change functionality.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A solar charging vehicle accessory comprises:
a substrate member to cover at least a portion of an electric vehicle, the substrate including a top surface and a bottom surface; and
a solar panel coupled to the top surface of the substrate;
an electric coupler to electrically couple the solar panel to at least one of an electric drive of the electric vehicle and a battery pack of the electric vehicle.

2. The solar charging vehicle accessory according to claim 1, wherein the electric vehicle is an electric pickup truck and the solar charging vehicle accessory is a tonneau cover to cover a bed of the electric pickup truck.

3. The solar charging vehicle accessory according to claim 1, wherein the electric vehicle is an electric pickup truck and the solar charging vehicle accessory is cap to cover a bed of the electric pickup truck.

4. The solar charging vehicle accessory according to claim 1, further comprising an actuator to change an angle of the solar panel.

5. The solar charging vehicle accessory according to claim 1, further comprising a cooling system including at least one air intake disposed on an end of the substrate member facing a direction of travel of the vehicle, at least one air outlet to discharge the air from the at least one air intake, and a battery pack, the air from the air intake cooling the battery pack.
